(19) United States
(12) Patent Application Publication
(10) Pub. No.: US 2011/0210616 A1
(43) Pub. Date: Sep. 1, 2011

(54) Binary impedance method

(76) Inventor: Daniel E. South, Palmer, AK (US)

(21) Appl. No.: 12/660,413

(22) Filed: Feb. 26, 2010

(51) Int. Cl. H01F 38/00

(52) U.S. Cl. 307/104

(57) ABSTRACT

An electrical circuit, two methods and two energy transformation processes are disclosed in support of invention of the electrical motor apparatus disclosed in which the electrical energy provided to operate the motor is recycled and reused by the invented circuitry incorporated in the Binary Torque Motor.

### CROSS-REFERENCE TO RELATED APPLICATIONS

This patent application claims priority from provisional patent application No. 61/338,881 having a filing date of Feb. 26, 2010.

### FIELD OF THE INVENTION

The invention pertains to the field of electrical circuits and devices which are utilized to optimize the delivery of electrical power to and from electrical circuits, devices, or components which consume, produce or store electrical energy.

### BACKGROUND OF THE INVENTION

Electrical power dissipation relates to the flow of electrical current in circuits, devices or components. Electromotive force (EMF) from an electrical power source causes current to flow through circuits, devices or components and return to the power source.

Conventional power conditioning devices used to increase the efficiency of operation of large inductive loads such as industrial scale motors are limited to improving the ratio of consumption of apparent power versus actual power, with no possibility of raising the ratio higher than unity for a sustained period of time.

There is a widely known need for improvements in the area of efficiency of energy usage, particularly in the area of vehicle energy storage and power train systems, but also for numerous other government, industrial, educational, commercial and private applications.

### BRIEF SUMMARY OF THE INVENTION

It is an object of the invented circuitry to accomplish the recycled delivery and reuse of electrical power originally produced, consumed or stored by the operation of a circuit, device or component.

In the invented circuitry, pairs of two or more electric consumption, storage, or production devices are connected in series with opposite polarity. Between them is added a system of inductively coupled coils through which typically the extensions of the polarity conductors and the common conductor are wound. The inner coil is the typically the common conductors and the outer coils are the separate polarity conductors—only connected at the same end as their device and open at the other end. The windings are electrically insulated from one another but possess a high degree of mutual inductance. The common current flowing in the inner coil induces a voltage in the outer coils separate windings and the polarity current and voltage is recycled at the polarity connector of each device.

The invention includes the following: the invented circuit—Binary EMF Circuit; a method utilizing the circuit—Binary EMF Method; a process utilizing the method—Binary EMF Process; another method utilizing the first method in electromechanical devices such as electrical motors and generators—Binary Torque Method; another process utilizing the second method—Binary Torque Process; and an apparatus utilizing all previous items—Binary Torque Motor.

Regarding prior art, to the best of my knowledge no patent exists for such a concept or device such as the invention herein disclosed, however the object of the invention to increase the efficiency of operation of an electrical device(s) is generally related to power conditioning devices.

### BRIEF DESCRIPTION OF THE SEVERAL VIEWS OF THE DRAWING

FIG. 1—Binary Torque Motor—Rear Side View

Rear Side View with case rear cover removed;

This is the front page view of the application;

FIG. 2—Binary Torque Motor—Front Side View

Front Side View with case front cover removed;

FIG. 3-6—Binary EMF Circuit Examples

FIG. 3

The circuit is shown between a pair of universal motors;

Applies to AC, pulsed and intermittent DC supply;

FIG. 4

The circuit is shown between a pair of AC generators;

Applies to AC type of generated supply;

FIG. 5

The circuit is shown between a pair of rechargeable batteries;

Applies to pulsed and intermittent DC supply;

FIG. 6

The circuit is shown between a pair of discharging inverters;

Applies to AC type of inverted supply.

### DETAILED DESCRIPTION OF THE INVENTION

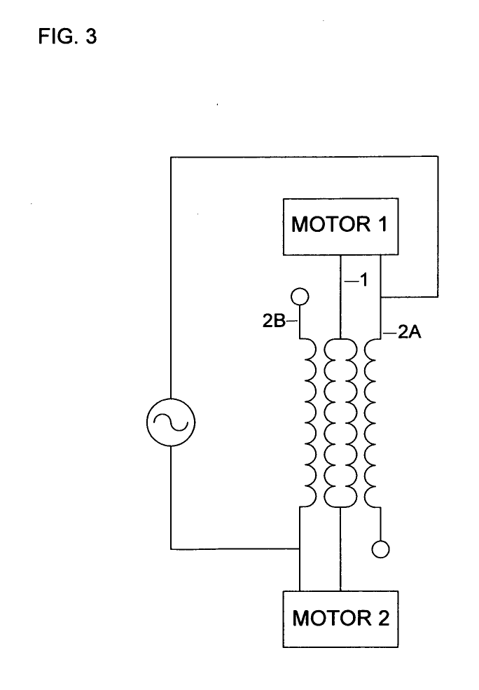

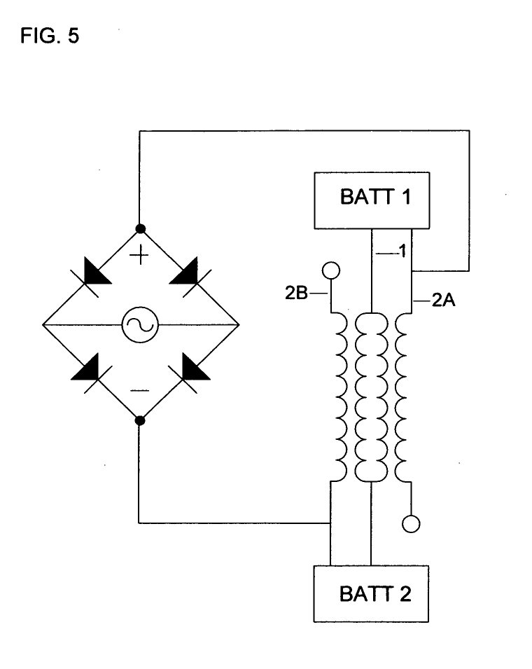

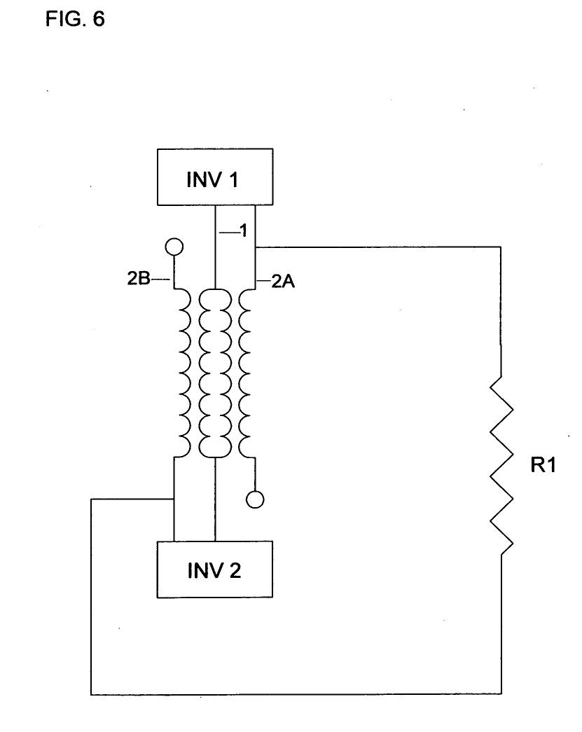

The drawing FIGS. 3-6 provide four examples of the Binary EMF Circuit diagram, the accompanying method of utilization—Binary EMF Method, and the underlying energy transformation process—Binary EMF Process.

The recycled delivery and reuse of electrical power consumed or stored is accomplished by electrically encapsulating two or more similar electricity consuming circuits, devices or components into a series circuit with opposite polarity orientation which is then divided by mutual inductance coils 1 & 2 comprised of the polarity supply conductors—or their extensions 2A & 2B , and the common supply conductors—or their extensions 1, supplying the electromotive force to operate the circuit, device or component. Construction of the mutual inductance coils 1 & 2 to include the electrical supply conductors 1 & 2 is performed in a manner intended to decrease the internal current flow between the series connected circuits, devices or components, which in turn reduces the external current flow and external circuit power expenditure.

A set of inductively coupled coils 1 & 2 arranged between two series connected circuits, devices or components electrically connect 1 the devices common connections—but only inductively connect each one half of the polarity connections 2A & 2B separately to the coils(s) 1 & 2 wound from the common conductors 1. The polarity winding conductors 2A & 2B are electrically insulated from the common coil windings 1, from earth ground, and from one another, but they possess a high degree of mutual inductance to the common coil windings 1.

The common winding coil(s) 1 electromagnetic fields induce voltage in the polarity conductors windings 2A & 2B, and the recycled polarity current flows back to the polarity input terminal of the circuit, device or component. The effect is to limit the internal circuit current flow, while still providing EMF and current necessary to operate each series connected circuit, device or component.

With the benefit of the implementation of invented circuit, some of the current caused by the EMF source originally to flow in the external circuit flows through each of the pair of internal circuits, devices or components more than once before returning to EMF source. The induced voltage and resulting polarity supply current is essentially recycled.

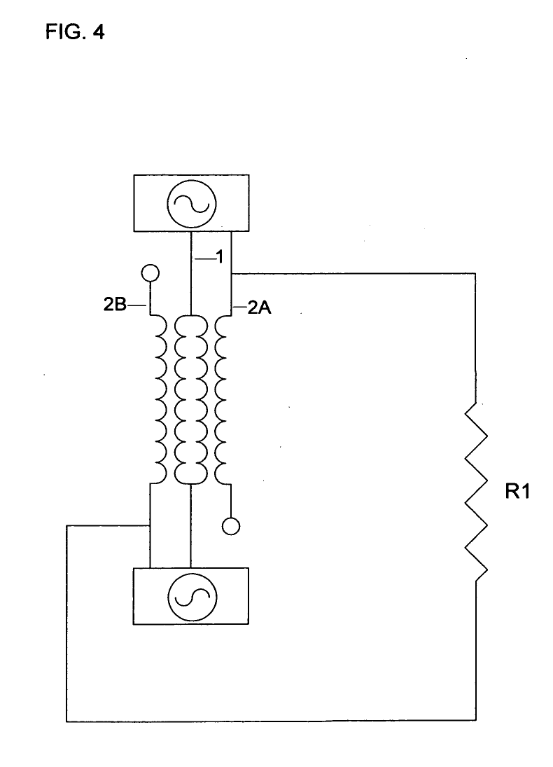

The same circuit is utilized for pairs of electricity producing circuits, devices or components but the installation is between a pair of electricity producing circuits, devices, or components such as two 120 VAC generators or storage inverters—FIGS. 4 & 6. The beneficial effect is to reduce the internal current load and input energy load while maintaining power output to external load. Essentially, some of the internal circuit current is recycled to each of the output polarity connectors 2A or 2B of the generation device pair.

In some other embodiments (not shown), the inner and outer coils system may appear segmented and distributed throughout other electrical and electromechanical mechanisms. They may also exist in various other configurations of electrical and electromechanical nature, as in the case that one or more other connections to the coil or other connections to the rest of the circuit, device or component are grounded or supplied with various voltage and current levels and waveforms.

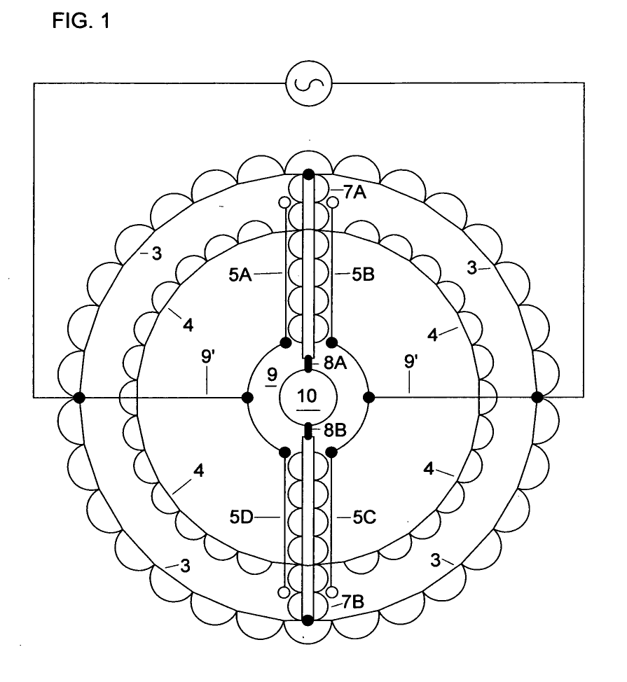

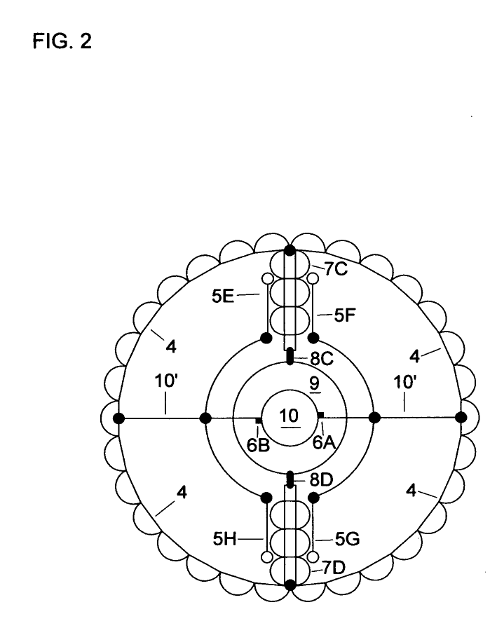

The drawing FIGS. 1-2 provide illustrations of the Binary Torque Motor, based on the Binary Torque Method of implementation of Binary EMF Circuit/Method/Process into an electrical motor of new manufacture, and the underlying energy transformation process—Binary Torque Process.

The Binary Torque Motor is series wound mutual induction motor with dual slip rings designed to be started and operated on alternating current voltages. Both the conventionally wound stator 3 and similarly wound rotor 4 are energized to operate the motor, and both incorporate features of Binary EMF Circuit into their supply and recycle circuit. An AC source symbol is shown, but the necessary solid state control device to regulate the operation of the motor is not shown—it would appear in the internal conductor 9′.

There is a typical housing case (not shown) with removable front and rear covers (not shown) and a typical mounting bracket (not shown). There is stationery main shaft 10 extending out of center of rear of case which is either grounded in single unit operation, or a floating voltage level when multiple units are electrically connected to operate in sets.

There is dual diameter slip ring 9 & 10—larger diameter is polarity supply voltage and smaller is extension of main shaft 10 ground rod/inner slip ring. Larger slip ring 9 does not extend out of back of case like main shaft, instead it terminates in rear view as connector to internal conductors 9′ and 5A-D as shown. Recycle coil assemblies 7A-B connect from stator at 90 degrees from polarity supply conductors 9′ with brushes 8A-B connecting to stationery inner slip ring/ground rod 10.

Ground rod/smaller slip ring 10 extend as slip ring in front view as does larger slip ring 9 and connects to neutral connection conductor 10′ with brushes 6A-B. Brushes 8C-D connect recycle coil assemblies 7C-D from polarity supply slip ring 9 to rotor coils 4 at 90 degrees from neutral connection conductors 10′ and 5E-H as shown.

To operate the motor, the proper design voltage and frequency of the AC supply is provided at the source symbol and the main shaft/ground rod 10 is grounded. Stator 3 current flows and rotor 4 current flows and both create magnetic fields which cause the rotor 4 to turn clockwise when viewed from the front. Stator 3 recycle benefit is accomplished by recycle coils assemblies 7A and 7B, which energize polarity supply conductors 9′ from their extensions 5A and 5D for one AC half cycle voltage polarity, and from their extensions 5B & 5C for the other AC half cycle voltage polarity. This performs the method of recycling EMF to stator 3 coils and thereby requiring less input EMF to continue to operate.

The operation of the rotor 4 and it's recycle circuitry is analogous to that of the stator 3, with the neutral polarity AC being supplied to it rotating coils 4 and an opposite polarity recycling operation occurring in it's recycle circuitry.

In the practice of the inventive concepts, multiple circuits, devices and components of many configurations and combinations may be produced. The application of the invention includes utilization internally or externally to various types of sink, source, or storage type of electrical circuits, devices or components of either existing or new manufacture, and may also be incorporated in new manufacture of electrical circuits, devices or components.

1. An electrical circuit—also known as Binary EMF Circuit—comprised of a set of electrically insulated but inductively coupled coil windings connected to both of the polarity and the common supply conductors and placed between two or more electrically similar devices connected in series with opposite polarity.

2. A method of use—also known as Binary EMF Method—of electrical circuit claimed in claim 1 to optimize the delivery of electrical energy to or from a pair or more of electricity producing, consuming or storage circuits, devices or components.

3. A process—also known as the Binary EMF Process—using the method claimed in claim 2, to transform the electrical energy produced, consumed or stored by a circuit, device or component into electromagnetic field energy and back into electrical energy to be recycled and reused or redelivered and resupplied to or from a pair of more of electricity producing, consuming or storage circuits, devices or components.

4. A method of use—also known as Binary Torque Method—using the circuit claimed in claim 1 in the construction of a mechanism such as an electrical motor or generator which converts electrical energy to or from mechanical energy to optimize the delivery of electrical energy within, from or to the mechanism or it's components.

5. A process—also known as the Binary Torque Process—using the method claimed in claim 4 in a mechanism such as an electrical motor or generator which transforms electrical energy to or from mechanical energy to transform the electrical energy produced, consumed or stored by the mechanism into electromagnetic field energy and back into electrical energy to be recycled and reused or redelivered and resupplied within, to or from the mechanism.

6. An apparatus—also known as Binary Torque Motor—using circuit, methods and processes claimed in claims 1 through 5 in the construction of an electrical motor with the feature of recycling and reusing energy input from external source to operate the motor.
